(19) United States
(12) Patent Application Publication
(10) Pub. No.: US 2007/0256309 A1
(43) Pub. Date: Nov. 8, 2007

(54) Twisted trimmer line

(76) Inventor: John R. Fogle, Carefree, AZ (US)

Correspondence Address: LaValle D. Ptak, 28435 N. 42nd St., Cave Creek, AZ, 85331, US

(21) Appl. No.: 11/800,121

(22) Filed: May 3, 2007

Related U.S. Application Data
(63) Continuation-in-part of application No. 11/129,539, filed on May 13, 2005, now abandoned.

(51) Int. Cl. A01D 34/416; A01D 34/00; B26B 7/00

(52) U.S. Cl. 30/276; 56/12.7

(57) ABSTRACT

An elongated string trimmer line has a filament body with a longitudinal axis and having a non-circular cross-sectional shape, where the filament body contains 80% or more of the total mass of a length of comparable string trimmer line having a circular cross section of a diameter equal to the diameter of a circle circumscribing the cross-sectional shape of the filament body. The trimmer line is rotated about the longitudinal axis of the filament body from about 0.25 to 2.0 rotations per inch.

### RELATED APPLICATION

This application is a Continuation-in-Part of co-pending Application Ser. No. 11/129,539 filed on May 13, 2005.

### BACKGROUND

Rotary string trimmer machines utilizing lengths of nylon monofilament trimmer line or the like are widely used for cutting weeds and other vegetation. Typically, the trimmer line which is used in such machines is extruded nylon monofilament, generally having a circular cross section. Lines with a circular cross section exhibit a relatively high noise and a relatively high drag on the machine with which such lines are used. Efforts have been made to configure trimmer lines to reduce both noise and drag. It is desirable to provide an improved trimmer line which reduces noise and/or drag, and improves other characteristics of the line when it is operated in a string trimmer machine.

### BRIEF DESCRIPTION OF THE DRAWINGS

FIG. 1 is a perspective view illustrating a string trimmer machine of the type with which line of the present invention may be used;

FIG. 2 is a top perspective diagrammatic view of a rotating string trimmer head of the type with which lines of the invention may be used;

FIG. 3 is a perspective view of a section of a line configured in accordance with an embodiment of the invention;

FIG. 4 is a perspective view of a line having the same cross section as the one of FIG. 4 and configured in accordance with a variation of the embodiment shown in FIG. 4;

FIGS. 5 through 7 are cross sections of different embodiments of the invention;

FIG. 8 is a partial diagrammatic perspective view of the embodiment shown in FIG. 7;

FIG. 9 is a perspective view of the embodiments shown in FIGS. 7 and 8 configured in accordance with a feature of the invention;

FIGS. 10 through 22 are cross sections of string trimmer lines according to various embodiments of the invention;

FIGS. 22A and 22B are noise level and power comparisons, respectively, for a first twisted square cross section and round cross section trimmer lines;

FIGS. 23A and 23B are noise level and power comparisons, respectively, for a second twisted square twisted and round lines;

FIGS. 24A and 24B are noise level and power comparisons, respectively, for a quadra-lobal line, twisted and untwisted, and round lines;

FIGS. 25A and 25B are noise and power level comparison, respectively, for a truncated star line, twisted and untwisted, and round line;

FIGS. 26A and 26B are noise and power level comparisons, respectively, for a four-tabbed line, twisted and untwisted, and round line;

FIG. 27 is a noise comparison chart of various types of line;

FIG. 28 is a power comparison for the same types of line shown in FIG. 27;

FIG. 29 is a field test wear graph comparing a first twisted square line with a comparable round line;

FIG. 30 is a field test wear graph of a second square twisted line versus a comparable round line;

FIG. 31 is a field test wear chart of a truncated star line, both twisted and untwisted, versus a comparable round line;

FIG. 32 is a field test wear chart of a four-tabbed line, both twisted and untwisted, versus a comparable round line;

FIG. 33 is a summary table illustrating features of embodiments of the invention; and

FIGS. 34 to 37 are graphs of noise and power studies.

### DETAILED DESCRIPTION

As used in the following specification and claims, the term string trimmer line refers to elongated line filaments used in string trimmer machines. The line filaments typically are in the form of extruded monofilament nylon or other equivalent materials.

Reference now should be made to the drawings, in which the same reference numbers are used throughout the different figures to designate the same components.

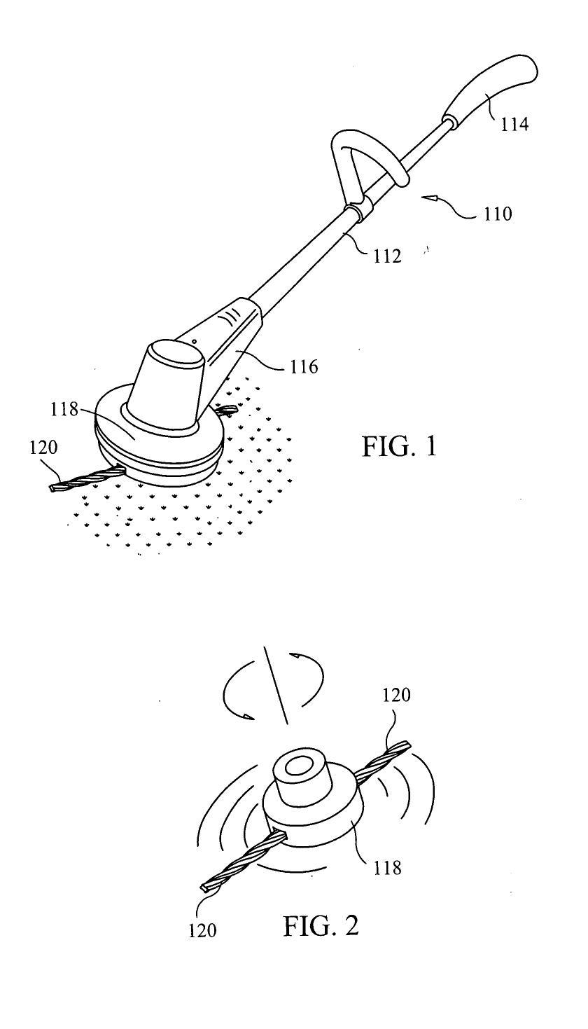

FIGS. 1 and 2 depict the general type of string trimmer machine with which embodiments of the invention are to be used. Such machines 110 typically include an elongated tubular portion 112 having an upper handle 114 and a lower motor 116. The machine 110 has an operating head 118, out of which a single length or pair of lengths (or more) of string trimmer line 120 extend.

The machine 110 which is shown in FIG. 1 has a configuration generally used for electric string trimmers. When a gasoline powered string trimmer machine is used, the motor typically is located at the upper end 114 of the portion 112, and operates through a rotating shaft located within the portion 112 to rotate the head 118. In either event, the operation, so far as the trimmer line 120 is concerned, is the same. This operation generally is represented in FIG. 2, where the head 118 is rotated continuously in a circular direction (as shown by the arrow) to spin the extended lengths of string trimmer line 120 for cutting vegetation.

Typically, the trimmer line 120 is made of extruded monofilament plastic or nylon line. Typical diameters of conventional circular cross-section range from 0.050″ to 0.0155″. The rotational speed of the heads used in trimmers of the type generally shown in FIG. 1 are between 2,000 to 20,000 RPMS. The high speeds of operation of such machines result in a significant amount of noise produced by the spinning line itself; and the line also creates substantial drag on the drive motor of the machine.

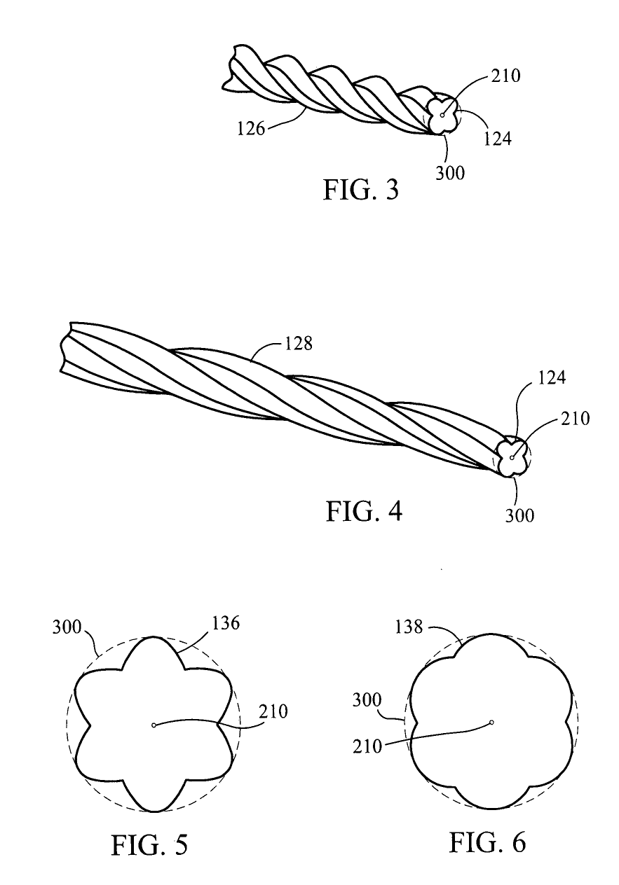

In accordance with various embodiments of this invention, it has been found that rotated or twisted extrusions of the line such as the line 120, but in various non-circular cross-sectional configurations as depicted variously in FIGS. 3 through 22 significantly improves the operating characteristics of machines using the line over the characteristics using the same line in a non-rotated or non-twisted form. All of the configurations of string trimmer line in FIGS. 3 to 22 have either a plurality of elongated protruding lobes extending from the filament body, or elongated grooves extending into the body of the filament forming the line. The lobes (or grooves) are in a pattern of rotation about a longitudinal axis 210 of the filament body, with between 0.25 to 2.0 rotations per inch of the length of the filament body or string trimmer line.

Although various cross-sectional configurations are shown throughout the different figures of the drawings, whenever a line having any one of these cross-sectional configurations is constructed with a rotation or spiral configuration resulting in rotation of the protruding lobes (or grooves) of between 0.25 to 2.0 rotations per inch, every cross section of the line taken on planes perpendicular to the longitudinal axis of the main body portion of the line is the same; although the different cross sections are rotated relative to one another. Typically, the rotations form a rotating spiral pattern which varies continuously by a constant amount along the longitudinal axis 210 of the filament body.

It also should be noted, in conjunction with the various FIGS. 3 through 22, that the filament body constitutes that portion of each of the various illustrated cross sections perpendicular to the axis 210 which lies within a circle 300, centered at axis 210, and having a radius equal to the greatest distance of any part of the body from the centroid 210. For example, in conjunction with the cross section of the four-lobed line 122 shown in FIGS. 3 and 4, the filament body is encompassed within a circle 300 which touches the four outermost points or protrusions of the four lobes. The circle 300 represents the cross section of a conventional circular line providing the nominal “size” of a line for reference purposes. In every case of all of the cross-sectional configurations shown for all of the various lines of FIGS. 3 through 22, the filament body, as generally defined above, has a longitudinal axis 210 (or axis of twist) extending throughout the length of the trimmer line.

Although the filament body nominal dimension is defined by the circle 300, the overall filament body may be symmetrical in cross-sectional configuration, or it may be asymmetrical. This also is true of the lobes which are formed with or extend outwardly from the filament body; although in most commercial applications of the invention, the filament body and the lobes will be symmetrically arranged. Situations may arise, however, where asymmetrical configurations of either or both the filament body and the protruding lobes may be desirable. Such a configuration is shown in FIG. 19.

FIGS. 3 and 4 illustrate a line of a cross-sectional configuration 124 which includes four equi-angularly spaced lobes about the filament body. In FIG. 3, a relatively tight rotation or twist of the lobes about the central axis of the filament body is illustrated. This produces a relatively large number of bumps or nodes per unit length along a line extending parallel to the central axis of the line. In FIG. 4, the same cross-sectional configuration of the line 124 is shown; but the rotation of the four lobes of the line is much less. Thus, the number of bumps or nodes 128 along a unit length of the line is less than the number of bumps, nodes or protrusions 126 along the same unit length of the line as shown in FIG. 3.

As noted above, the number of twists or rotations of the line to produce the bumps or nodes per unit length of the line at its surface is established by twisting or rotating the line between 0.25 and 2.0 rotations per inch. FIG. 4 illustrates the result of the lower range of such rotations, whereas FIG. 3 illustrates the result of the greater amount of rotations per inch within this range or set of parameters.

It also should be readily apparent from a consideration of FIGS. 3 and 4 that the number of bumps or nodes which are experienced per unit length of the line increases as the number of protruding lobes in the line cross section increases from, for example, three lobes to some maximum number (typically twelve lobes appears to be at the upper range of the number of lobes which can be used on commercial string trimmer line applications). Twelve lobes will generate twenty-four bumps or nodes per inch at a twist level of two twists per inch.

It should be noted in conjunction with the ensuing description of the various line cross-sectional configurations that the different lines all are twisted or rotated in accordance with the illustrations of FIGS. 3 and 4 for the line cross section 124. The practical range of rotations or twists per inch is 0.25 to 2.0, as discussed above, to produce the ideal line characteristics for any given line cross section configuration. It has been found that with any cross-sectional configuration, the noise and drag of the line is higher for untwisted lines than it is for twisted lines. In addition to a reduction of noise and drag (not always in direct linear relationship with one another), lines which are configured with the various configurations of protruding lobes illustrated in FIGS. 3 through 22, also exhibit more stable cutting paths, that is there is less flutter at the line tip than occurs when untwisted lines having the same cross-sectional configuration are operated. It also appears that those twisted lines recover more quickly to a plane perpendicular to the drive shaft axis after being deflected by striking ground, grass, or other obstacles. This is particularly advantageous when edging flower beds, golf course traps and the like. Borders with a straighter and cleaner cut are the result.

It also has been discovered that the rotated or twisted lines producing an alteration between high and low areas (peaks and valleys) parallel to the axis exhibit more aggressive cutting characteristics. This is believed to occur as a result of a sawing effect caused by the high and low, or peak and valley, configurations which result from rotating the lobes about the axis of the filament body during the manufacturing process while the line is still soft and before it hardens. The rotation may be effected in any suitable manner, and typically occurs by rotating the entire extrusion (filament body and lobes extruded simultaneously) about the axis of the body. Other methods, however, may be employed to obtain the end result which is diagrammatically illustrated in conjunction with the four-lobed cross-sectional configuration 124 in FIGS. 3 and 4. The same principles apply, however, for all of the other cross-sectional configurations which are illustrated in FIGS. 3 through 20.

In FIGS. 5 through 22, the outer circle 300 circumscribes the external lobes or the external configuration of a grooved cross section (such as shown, for example, in FIGS. 13 and 14). The circle 300 represents the nominal line size equivalent to a conventional circular string trimmer line for determining the aperture of a string trimmer machine which must be provided in order to accommodate the various line configurations shown in FIGS. 3 through 22. The mass of the trimmer line, which is located within the circle 300 is selected to be 80% or more of the comparable mass of a conventional circular cross-section line of the same material and of the same density having the diameter of the dotted line circle 300, as shown in the various embodiments of FIGS. 3 to 22. If cross-sectional filament configurations are provided which have filament body masses with less than this 80% or more range, the line mass tends to be such that excessively rapid wear and lower impact energy (for the nominal line size defined by the circle 300) takes place even though reduced noise and reduced drag characteristics may exist. By providing the filament body defined by the outer circular cross section 300 to encompass at least 80% of the total mass of the comparable round or circular control (comparison) filament, an ideal compromise between the desired noise and drag reduction and maximum durability (reduced wear) is achieved. It is important to provide a balance between line configurations providing this mass relationship and twisted patterns of lobes and grooves which produce the desired reduced drag and reduced noise during use of the line in a string trimmer machine such as shown in FIG. 1.

It should be noted in conjunction with FIGS. 3 and 4, that the drawing is made diagrammatically in order to emphasize the nature of the different amount of twists occurring per unit of length. In order to do this, what appear to be sharp edges are illustrated; but it is apparent from an examination of the cross section on the right-hand end of the line segments shown in FIGS. 3 and 4, the edges are rounded with a concave interconnecting configuration between the four different lobes of the line. Consequently, no sharp edges actually appear in a twisted line using the cross-sectional configuration 124. The drawing, however, clearly shows the difference in spacing between the bumps or peaks along a unit length of line between the peaks 126 for the more tightly rotated configuration of FIG. 3 and the peaks 128 for the less tightly rotated configuration of FIG. 4.

FIGS. 5 and 6 show six-lobed cross-sectional configurations 136 and 138. The cross-sectional configurations 136 and 138 have similar main filament bodies, with the lobes extending from the main filament body of FIG. 5 protruding in greater amounts than those shown in FIG. 6. All of the various different lobe configurations and different numbers of lobes used on string trimmer line configurations in conjunction with the invention, may employ variations in the radial extensions of the lobes from the main filament body portion, as illustrated particularly in conjunction with FIGS. 5 and 6 and the cross-sectional line configurations 136 and 138. The choice of configurations depends on the cutting characteristics which are desired (configurations such as FIG. 5 will be more aggressive than the one shown in FIG. 6, for example).

It also is apparent from an examination of FIGS. 5 and 6 that the overall weight per unit length of the line of FIG. 5 is less than that of the line of FIG. 6 of the same external diameter, with the line of FIG. 6 constituting the heavier cutting line per unit length. Measuring line weight per unit length is a convenient method to determine the 80% minimum mass compared with conventional circular line with the same or similar material characteristics.

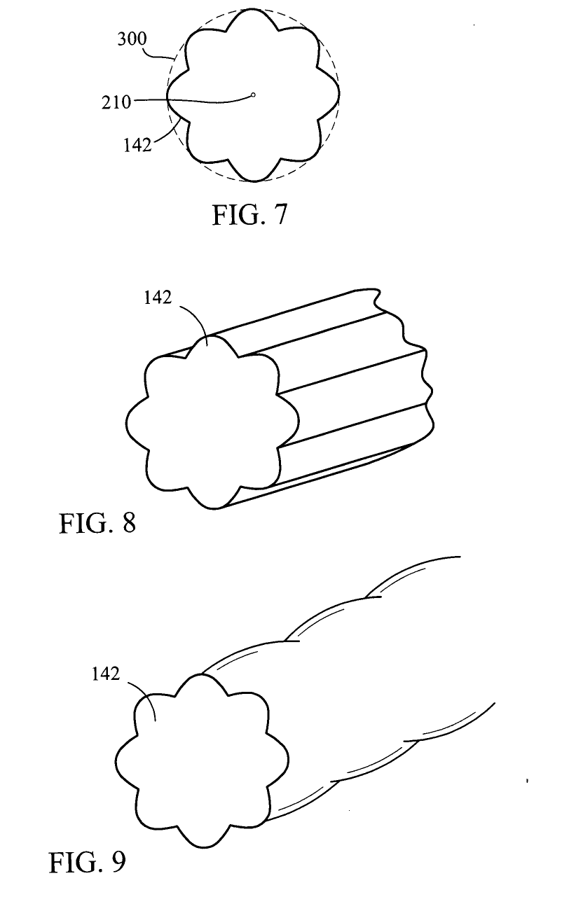

FIG. 7 shows eight-lobed line 142. The overall outer diameter 300, however, of the line segment 142 is substantially the same as in FIGS. 5 and 6.

FIGS. 8 and 9 show the line having a cross-sectional configuration 142 of FIG. 7 in an untwisted, elongated segment of FIG. 8, and then in a twisted segment in FIG. 9. FIG. 9 illustrates the application of the invention to a line having a cross section of FIG. 7 to depict it in a manner similar to the four-lobed line shown in FIGS. 3 and 4. The same principles which were explained above in detail in conjunction with FIGS. 3 and 4 apply equally as well to the line of FIGS. 7,8 and 9; so that a larger number of peaks or bumps occurs per unit length when a larger number of twists per inch are applied to the line than when a lower number of twists per inch are applied to the line. This is true of all of the line configurations which are illustrated in the various figures of the drawings.

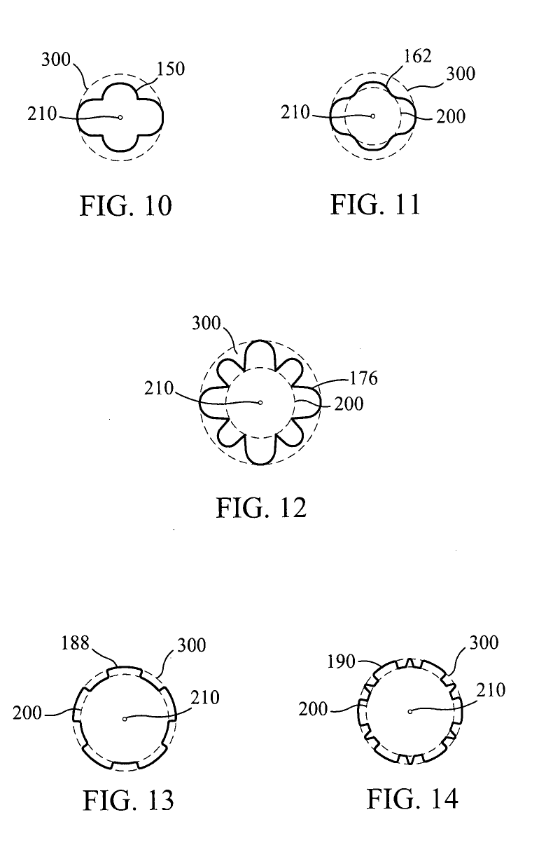

FIG. 10 shows a line cross section 150 similar to that of FIGS. 3 and 4, but with different relative protruding lobe relationships from the ones shown in FIGS. 3 and 4. FIG. 11 is similar to FIG. 10, but illustrates a line 162 with four protruding lobes, where concave interconnections between the different lobes, at the base of the lobe where they interconnect with the filament body, are employed. In the line 150 of FIG. 10, the intersections of the different lobes are at a sharp right angle instead of the concave interconnections of the line 162 of FIG. 11.

FIG. 12 is directed to an eight-lobed cross-sectional configuration 176 where four of the lobes are of relatively longer, wide, rounded cross-sectional configuration interspersed with four relatively shorter lobes of a narrower rounded cross-sectional configuration, where the longer, wide lobes extend to the same outer circular configuration 300. This configuration is referred to herein as a quad-lobe plus configuration.

FIGS. 13 and 14 are directed to different embodiments, in which the extending or protruding lobes do not touch or intersect one another. In both of these figures, the cross sections 188 and 190 show lobes which meet at an inner circular portion of the filament body, with a convex circular portion of the filament body clearly shown in each of FIGS. 13 and 14 between the various lobes.

In the configuration 188 of FIG. 13, the lobes are terminated in a convex concentric configuration. This also is true of the six lobes of the cross-sectional configuration 190 of FIG. 14 which constitute the larger lobes; but in the embodiment of 190, each of these six larger lobes have a smaller, generally triangularly shaped lobe extending between them outwardly from the filament body. Otherwise, the overall shape of the cross section 190 of FIG. 14 is similar to the cross-sectional configuration 188 of FIG. 13.

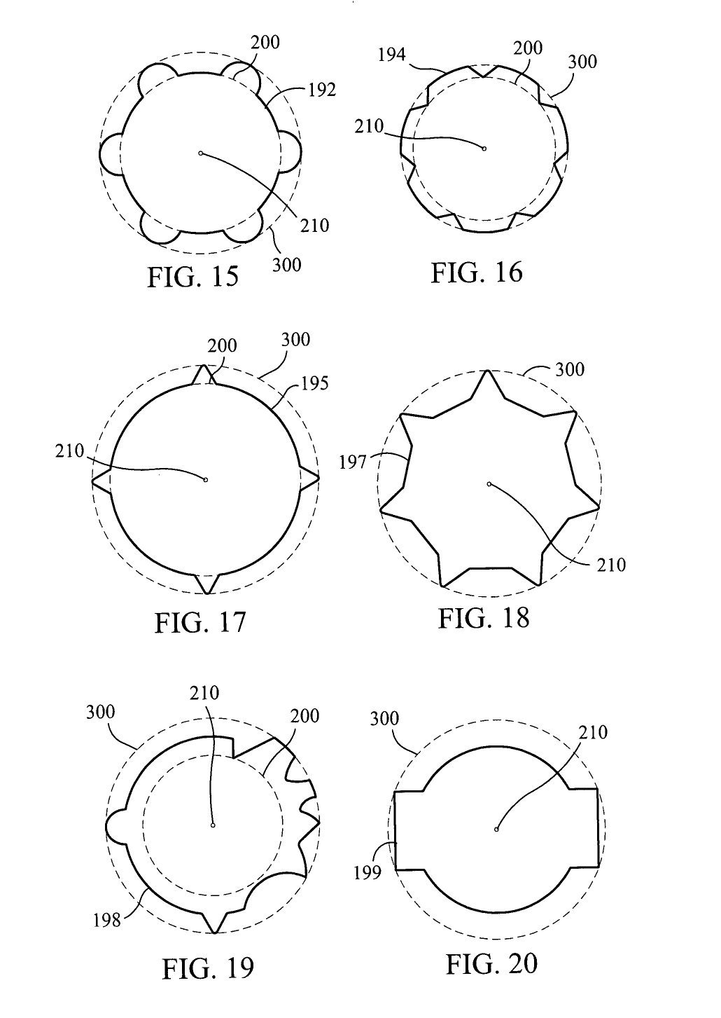

FIGS. 15 and 16 illustrate trimmer line cross-sectional configurations 192 and 194 for six-lobed lines and seven-lobed lines, respectively, having different configurations from the six-lobed lines illustrated previously. In FIG. 15, the lobes are equally angularly spaced from one another about the periphery of an underlying circular filament body, similar to the principles of the cross-sectional configurations 188 and 190 of FIGS. 13 and 14. In FIG. 16, the lobes are in the general form of trapezoids and the cross-sectional configuration 194 again is illustrated to show the wide variety of shapes which can be employed with the invention.

FIG. 17 is a four-lobed cross-sectional configuration 195, in which the filament body is defined by an inner circle which is a significant percentage of the overall cross section. The lobes are small, somewhat triangularly shaped projections spaced at 90° about the periphery of the inner filament body.

FIG. 18 illustrates a seven-lobed cross-sectional configuration 197, where again the lobes do not contact one another at the underlying filament body, but instead are spaced from one another about the periphery of the body. In FIG. 18, however, the interconnection between the bases of each of the adjacent lobes is a straight line rather than a section of a circle, or a concave depression as in the case of the embodiment shown in FIGS. 3 and 4.

FIG. 19 illustrates an asymmetrical cross-sectional configuration 198 with lobes of different shapes and sizes on the underlying filament body. Many other variations of asymmetrical configurations are possible.

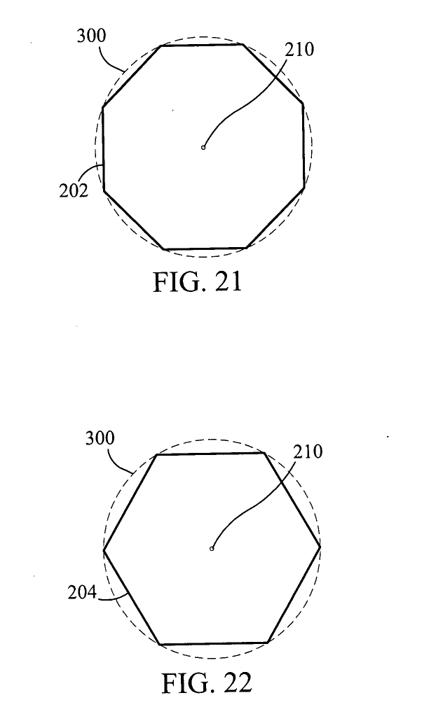

FIG. 20 illustrates a filament configuration where the filament body portion is defined by an inner circle 200 which comprises a major portion of the filament with a pair of rectangular protrusions diametrically opposite from one another on a portion of the filament body. The overall configuration is basically one of a rectangle superimposed over a circular cross section to form the body 199. Other variations of the concept disclosed in FIG. 20, including the superimposition of one or more additional rectangles across the underlying circular filament body, clearly are possible.

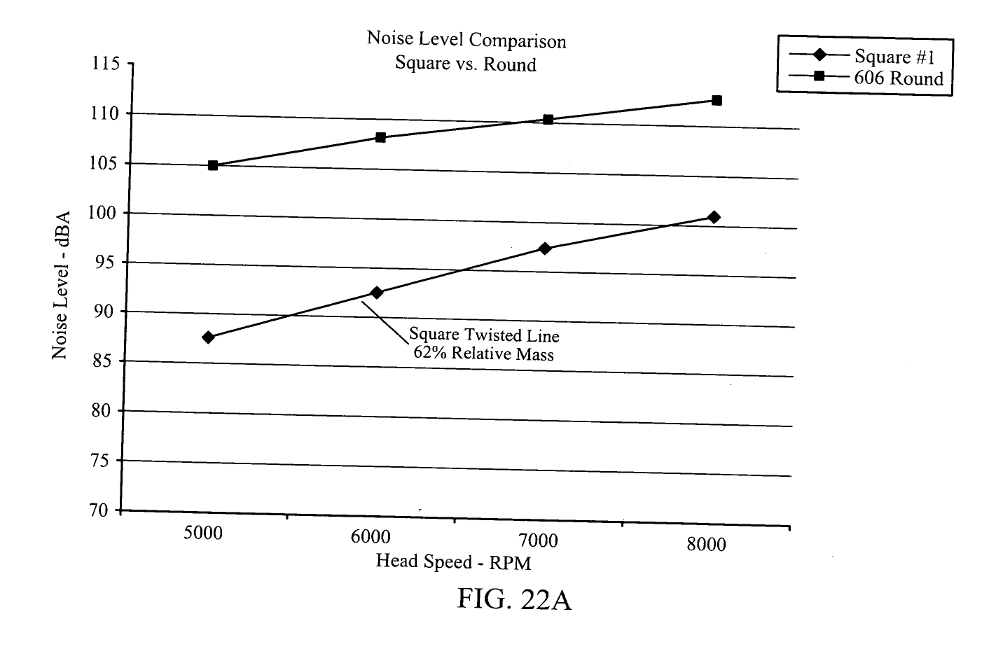

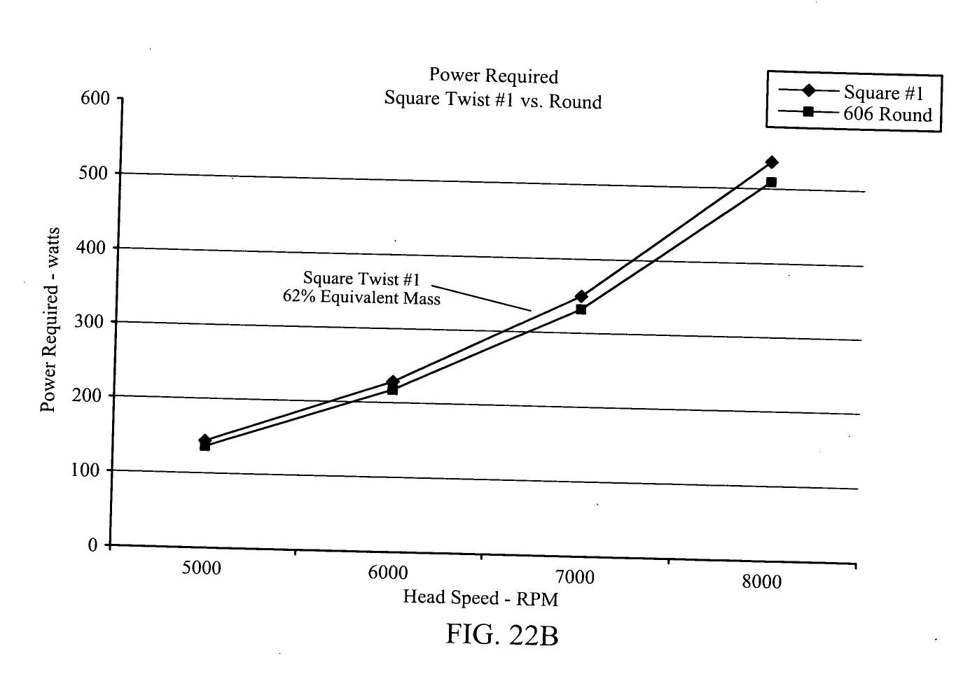

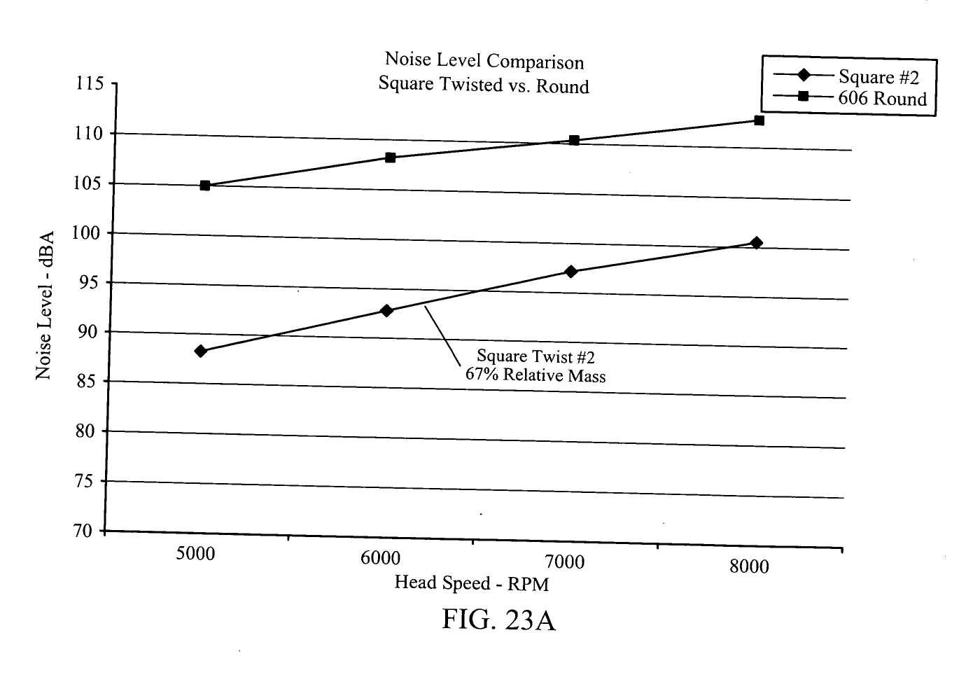

FIGS. 21 and 22 illustrate geometric shapes in the form of a hexagon and an octagon, respectively, which also comprise embodiments of the invention. Once again, the outer circle 300 (defining the diameter of a comparable standard circular cross section line) touches the corners of the hexagon 202 of FIG. 21 and the corners of the octagon 204 of FIG. 22. It should be noted that various numbers of sizes of straight-sided geometric shapes, such as pentagons, hexagons and multiple sided shapes greater than octagons, may be employed. The particular shapes are selected to have a mass calculated in accordance with the foregoing description which is at least 80% of a comparable diameter conventional circular cross-sectional line. It is to be noted that a line with a square cross section or a triangular cross section with straight sides does not have sufficient mass to meet the foregoing parameters, but instead falls below the 80% mass, lower limit discussed above.

It should also be noted that the interconnections of the various lobes can take any of a number of different configurations. The lobes may meet one another at their bases at a relatively sharp angle, providing a crease or line along a finished length of rotated line. Alternatively, the lobes may meet at a concave interconnection of the type illustrated in FIG. 11. Additionally, the lobes may be interconnected by means of convex or concave configurations interconnecting spaced-apart lobes, such as the types shown in the cross-sectional configurations of 192 (FIG. 15), and 195 (FIG. 17). It also may be desirable for some applications to employ flat interconnections between the different lobes, as illustrated with the cross-sectional configuration 197 of FIG. 18.

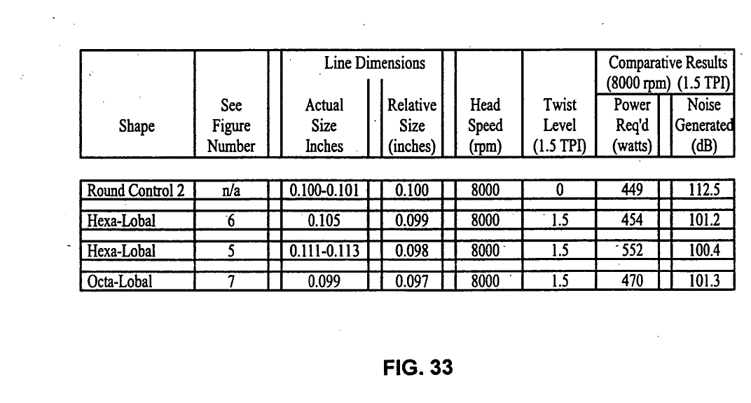

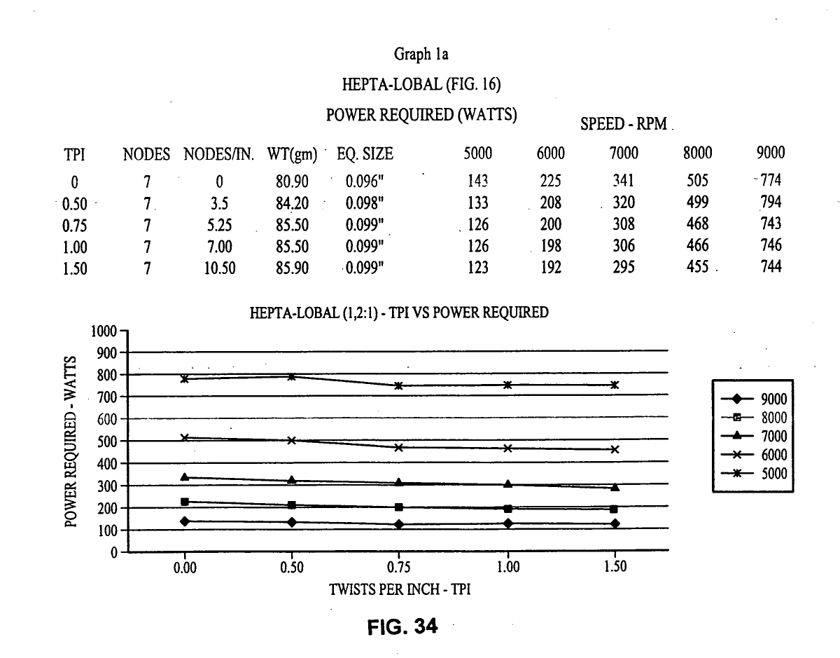

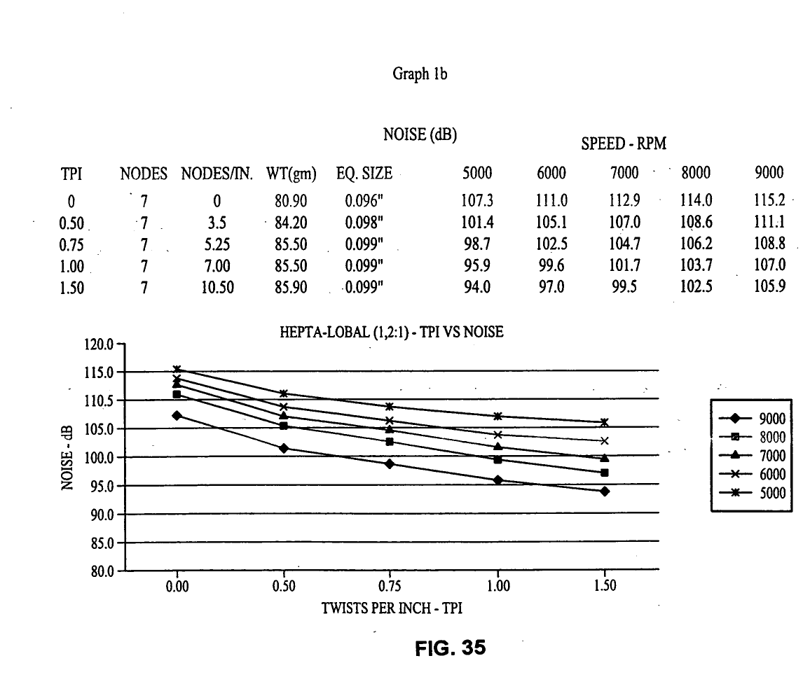

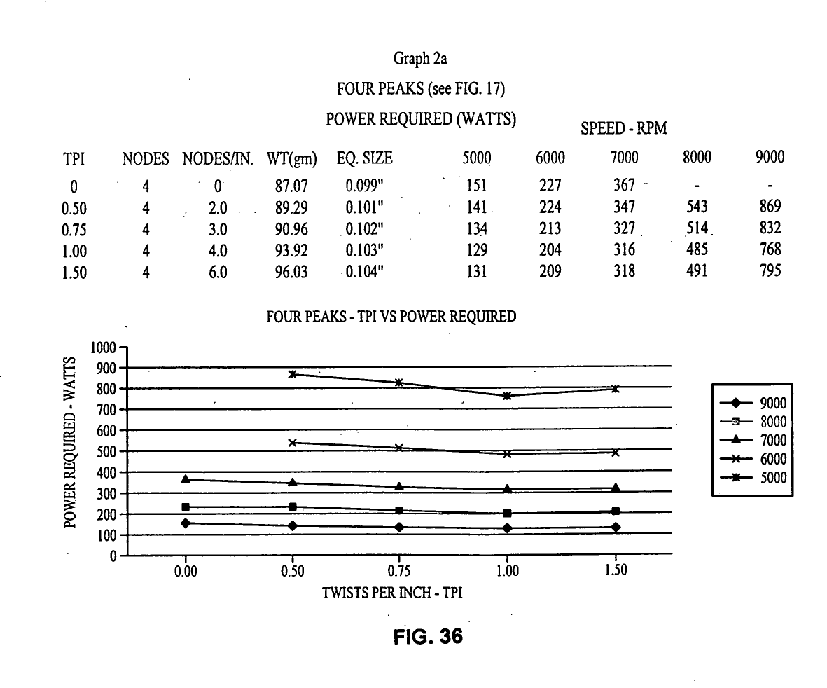

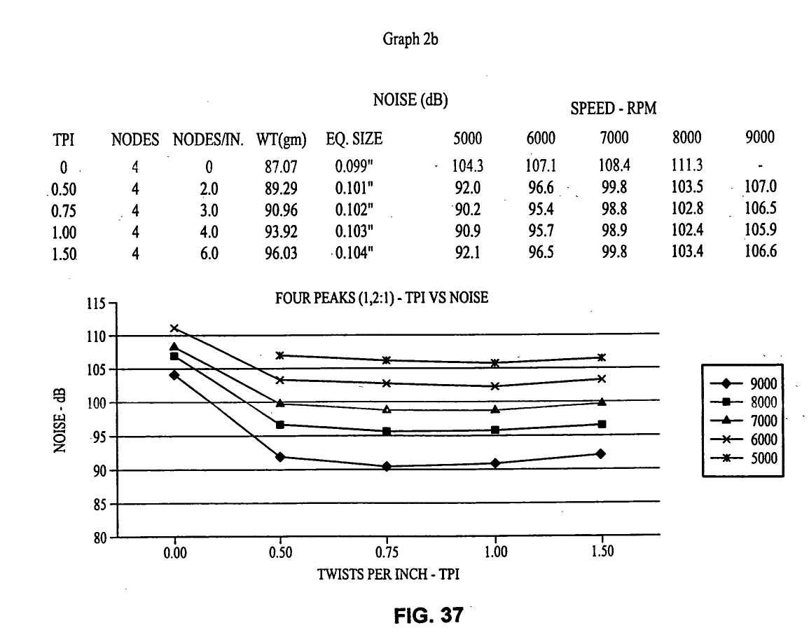

In order to verify the effect of twisting various line configurations at varying twist levels, the following methods, equipment and procedures were developed:
Extrusion dies for the variety of shapes to be tested were fabricated.
Shaped lines were extruded, and mass was determined by weighing 50′ of line. This provided a basis for comparing equivalent sizes of all lines.
all shaped lines were then twisted and set at levels of 0.0, 0.50, 0.75, 1.00, and 1.5 twists per inch (TPI).
Twisted samples were then tested for noise and drag using a test machine designed and developed by the inventor to provide exact speed control up to 10,000 RPM. The machine was driven by a 1 hp AC/DC motor equipped with a speed control feedback system. The test machine also was designed with the capability of measuring the power (wattage) required to operate the motor along with the attached trimmer head and line samples at the controlled speed.
Noise levels were determined by placing a Quest™ Technologies Model 2700 impulse sound level meter at a precise location near the rotating line samples.
Line samples were placed in the fixed head attached to the motor drive system. The motor was then stepped to 5000, 6000, 7000, 8000, and 9000 rpm's. The two line ends extended 5″ each from the head exit giving a total cut path of 14″. The noise level and power required was then recorded for each of the tested samples. In cases where there is no recorded data, either line flutter, or over power draw were the reason.
   The following examples recorded in the graphs and tables designated Graph 1a and Graph 1b (FIGS. 34 and 35) and Graph 2a and 2b (FIGS. 36 and 37) are representative of the results obtained for the variety of shapes and configurations studied. Both noise level and power required were reduced by twisting each configuration. The SUMMARY table (FIG. 33) provides an insight as to the difference in power required to rotate the two shapes selected. Data for 1.5 TPI at 8000 rpm was selected for the comparison. Note that the lobes vary from six to eight and the lobe height varies as is depicted in FIGS. 6 and 7.

Power required to rotate the head and line undergoes a general gradual decline as twists per inch (TPI) increase. The higher the head speed, the greater the decline. Equilibrium appears to occur for the higher speeds (those typical of commercial gasoline trimmers) from about 1.0 to 2.0 TPI. A family of curves is observed with decreasing slope (power reduction rate) as the head line speed is reduced from 8000 rpm to 5000 rpm.

The noise generated appears to decrease most rapidly at twist levels up to about 0.50 TPI. Some configurations tend to reach a noise minimum at 0.50 to 0.75 TPI and then begin to increase as the TPI increases, while others show a continued reduction in noise through 1.50 TPI with projected equilibrium at about 2.00 TPI. A similar result is observed for the noise studies for all shapes tested. Results of noise and power studies for the shapes tested may be seen in the graphs 1A and 1B of FIGS. 34 and 35 and graphs 2A and 2B of FIGS. 36 and 37.

As has been previously noted, providing lines with lobes or extensions from the main body, which are subsequently twisted, provide a trimmer line with a “saw tooth” effect. It has been found that lines configured in such a way provide significant improvement in cutting vegetation such as vines, brambles, blackberry bushes and the like. This is particularly true when the mass of the filament body calculated as described is at least 80% of the total mass of a comparable circular line 300. As seen in the table below, the number of cutting teeth provided is dependent on the number of lobes or extensions on the trimmer line, as well as the number of twists per inch.

### Nodes (Teeth) per Inch

After assembling, reviewing and interpreting the extensive data collected, tables were prepared for each of the different line configurations. Values for aspect ratio (where applicable), size, weight of 50 feet of line, line equivalent sizes, lobes, twists per inch (TPI) and nodes per inch (NPI), along with power required in watts and noise generated in decibels (dB) were recorded at 5000, 6000, 7000, 8000 and 9000 rpm. Definitions or descriptions of terms used in these tables follow:
Aspect ratio—in many of the shapes, a series of ellipses was used to form the cross section. For example, a quadra-lobal shape was obtained by arranging two of the same elliptical elements at 90 degrees and centered in respect to each other (see FIG. 6). These ellipses are defined by their height to width ratio. Therefore, the aspect ratio (height/width) of the individual components was used to define the shape of the body and the lobes.
Size—this value, which is the actual dimensional size of the line cross section (even though it includes grooves or hollow places in many cases). It was determined by rotating a representative cross section of the line sample 360 degrees in a micrometer and recording the minimum and maximum dimensions (the circle 300) in inches.
Weight (gm) per 50 ft.—A section of line was accurately cut to 50 feet and weighed to within a hundredth of a gram (gm).
Equivalent size—the line size calculated by comparing the mass of the specific shape of line under consideration to the size of a round line that would yield the same weight for the feet. The equivalent size is therefore the diameter of a round line of equivalent unit mass.
Lobes—Extensions or protrusions from the main body.
TPI—Twists per inch, or the number of revolutions per inch that the line is subjected to in the twisting process.
Nodes per inch (NPI)—The number of bumps or “teeth” along the length of the line. This is determined by multiplying the number of twists per inch (TPI) by the number of lobes on the subject line.
Head speed—The rate of rotation of the fixture (head) which holds and retains the line being tested normally expressed in revolutions per minute (rpm).

In the following figures, it is shown that shapes, when twisted, show improvements in both noise generated and power required when compared to the untwisted version of the same line.

Extensive testing of shaped samples provides ample proof of the effect of twisting on a variety of shapes. It is shown in FIGS. 22A to 32 that, after measuring the performance, noise generated, and power required for any particular shape, one may select a twist level from between 0.25 and 2.00 TPI and provide a line of improved performance when that line also has the 80% or greater mass determined in accordance with the foregoing definition. Since various different shapes previously have been sold and identified with specific markets, products, and/or suppliers, it is advantageous to know that any shape with the defined mass can be improved in performance by twisting from 0.25 to 2.00 TPI and selecting the best performing line in regards to cutting performance, noise reduction, or reduction in power required. Additionally, an optimum line may be configured which combines in a predetermined manner the noise, power required and cutting performance (as determined by nodes per inch).

The various cross-sectional shapes which are shown in FIGS. 3 to 22 and the relationships between the relative sizes of the circles 200 and 300 should be considered as representative, but not necessarily dimensionally accurate as drawn. These different figures are shown as representative of, but not as inclusive of, various shapes and configurations of the cross-sectional profiles of different trimmer lines representative of embodiments of the invention. It also should be noted that the trimmer lines shown in FIGS. 3 through 22 are configurations, primarily, where lobes, projections, or corners protrude from an inner circle 200 outwardly to define the outer circle 300. Other embodiments coming within the mass definitions which have been provided above can be made by “notching” an otherwise circular filament to achieve similar results to those explained above.

In order to understand more fully the unexpected results which have been obtained by the combination of the twisting described above in conjunction with the various figures and the size or mass compared with conventional round or circular cross-sectional configurations of trimmer line is presented in conjunction with FIGS. 22A through 32. These figures illustrate test results of lines falling outside of the defined 80% or greater mass ratio, discussed earlier, as well as lines which have different cross-sectional configurations, and which also include the above mentioned 80% or greater mass ratios, as defined previously.

FIGS. 22A and 22B are the noise level comparison and power requirement comparison of a twisted square cross-sectional line having a 62% relative mass obtained by the use of the above described computation based on the inner circle 200 and the outer circle 300, which can be drawn for such a configuration, compared with a round cross-sectional line having an outer diameter equal to the diameter 300 of the compared square cross-sectional line. The square line was twisted in accordance with the twist levels between 0.25 and 2.00 PPI described above. It is readily apparent from an examination of FIG. 22A, that the noise level is lower as a result of the twist, and that the power required is slightly lower.

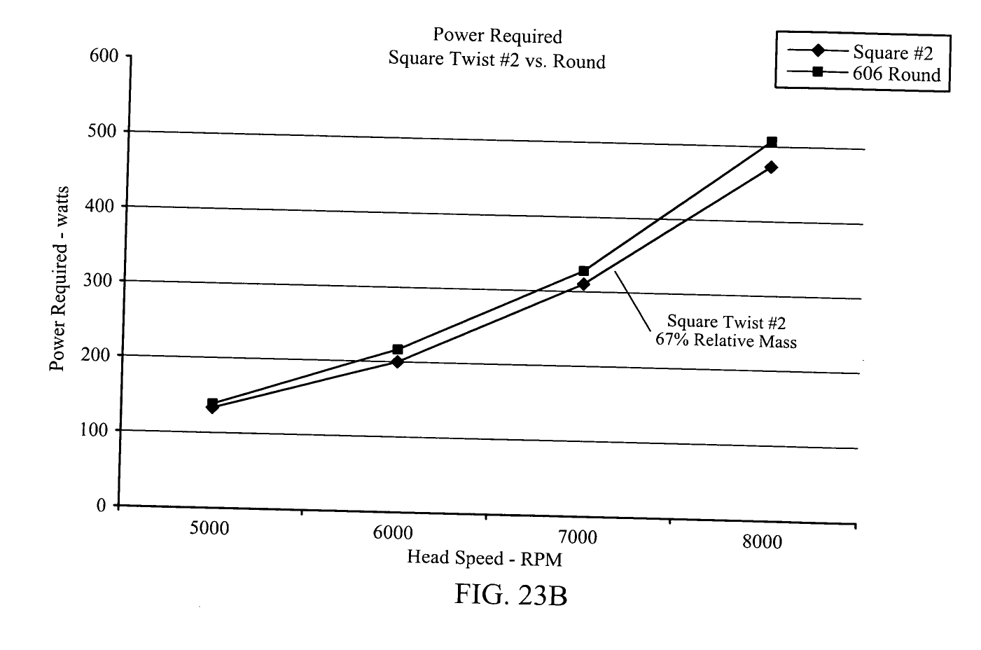

FIGS. 23A and 23B are similar to FIGS. 22A and 22B, except that a square cross-sectional line having a slightly greater relative mass than the one of FIGS. 22A and 22B is employed. As is apparent from an examination of these figures, results similar to those described above in conjunction with FIGS. 22A and 22B were found.

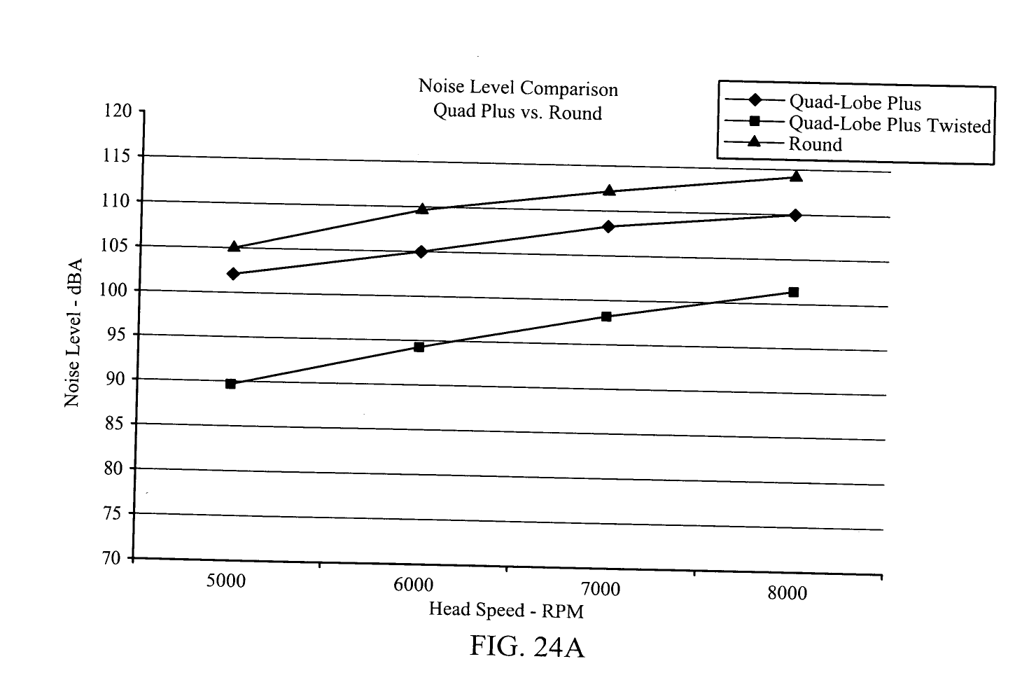

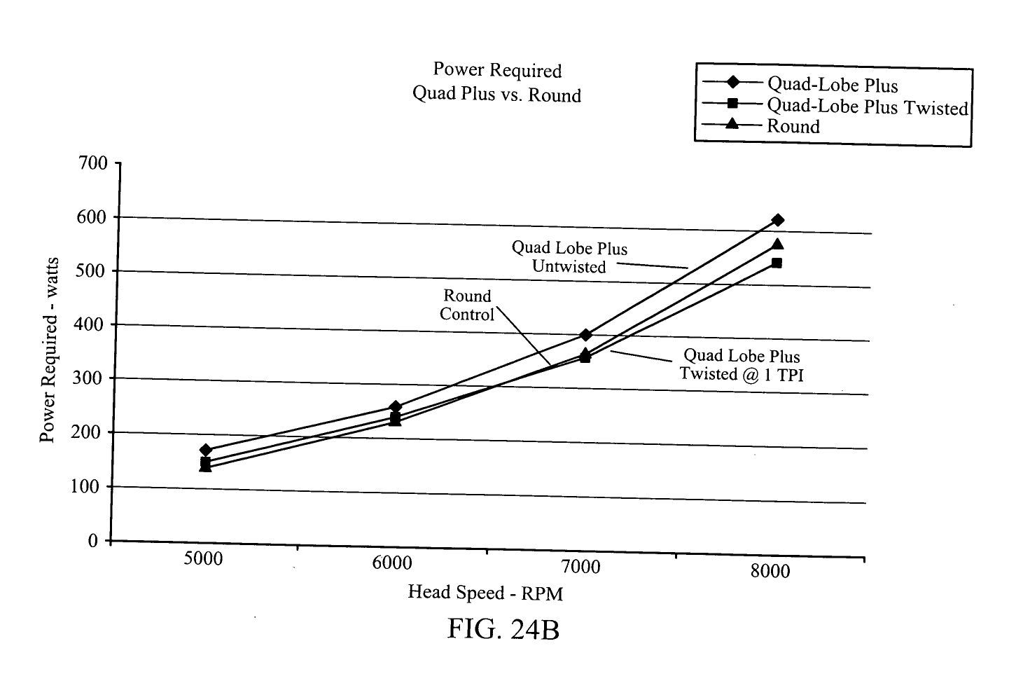

FIGS. 24A and 24B are directed to a noise level comparison and a power level comparison of a quad-lobe plus or four-lobed line similar to FIG. 12 and coming within the specifications of the 80% or greater mass as compared with a comparable round or circular cross-sectional control line. Twisted and untwisted operation of this quad-lobe plus line, as compared with the round line, is provided in these figures; and it again is readily apparent that the noise level comparison for the twisted line is substantially less than the noise level of the untwisted line. Again, as shown in FIG. 24B, the power required is slightly less than that required for the comparison round cross-sectional line.

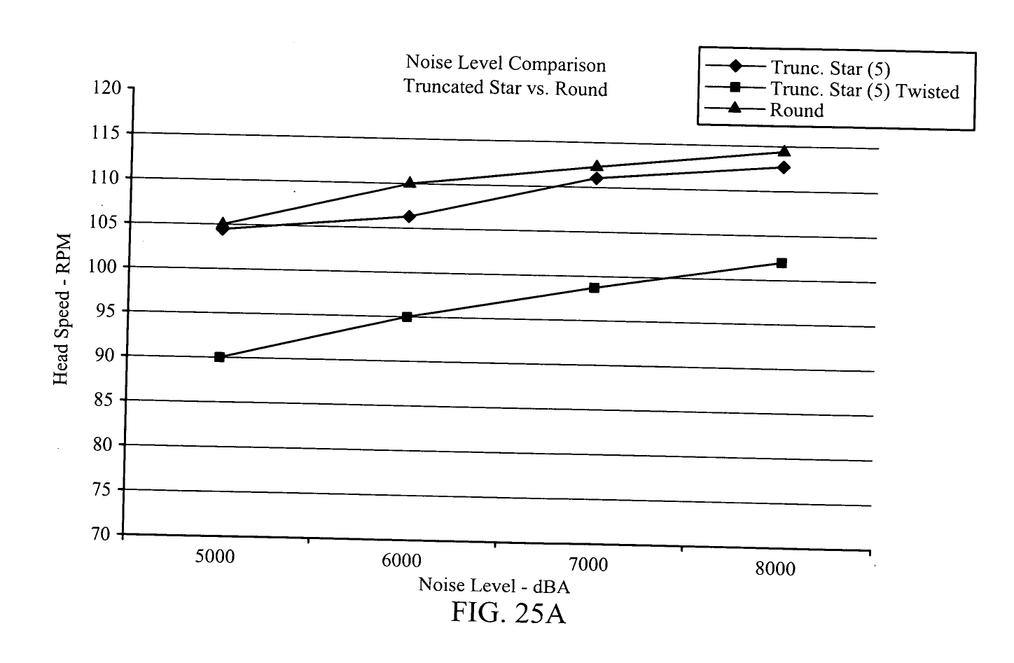

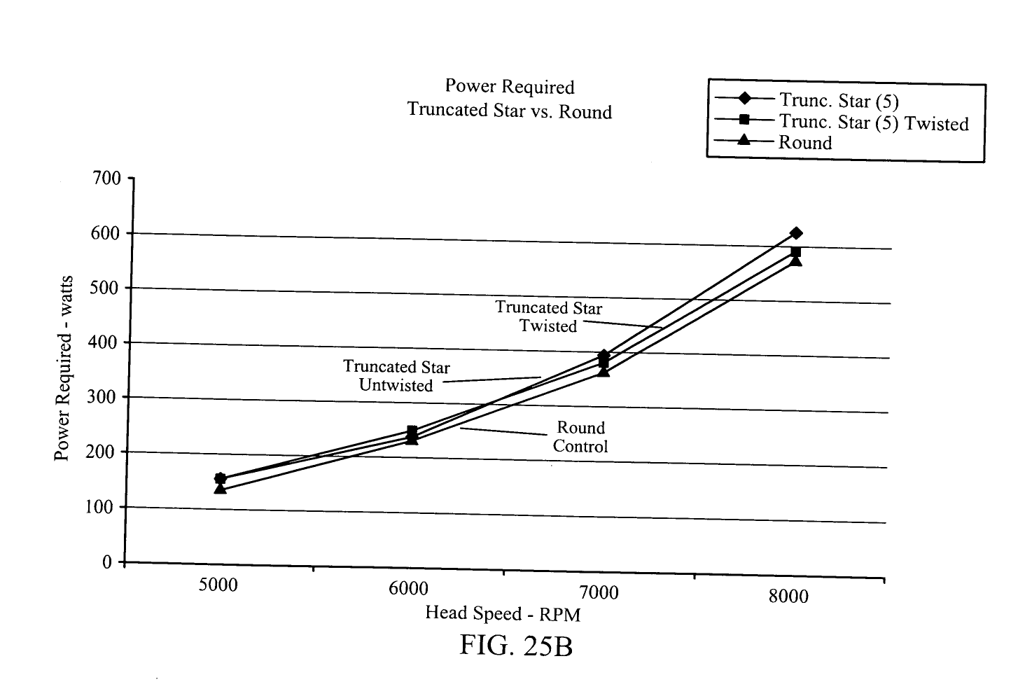

FIGS. 25A and 25B are directed to a noise level comparison and a power level comparison of a truncated star (having five peaks or lobes) versus a round line, where the truncated star again is configured within the 80% or greater mass described previously. Twisted and untwisted versions are shown in the actual comparison which was made; and it is readily apparent that the twisting significantly lowers the noise level; although there is only slight difference in the power required to operate this line.

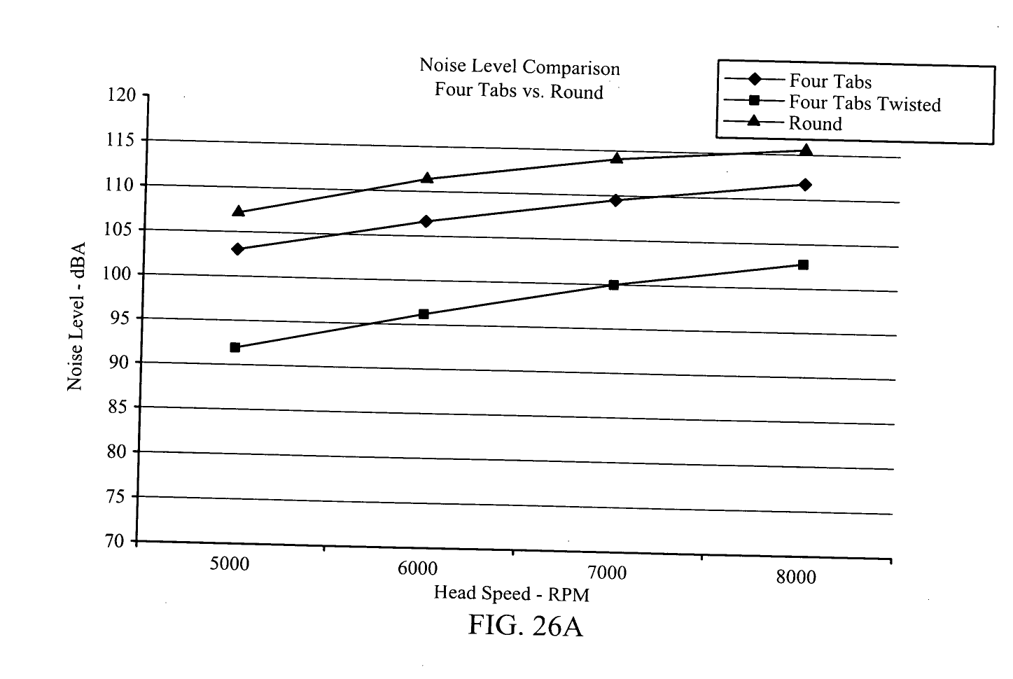

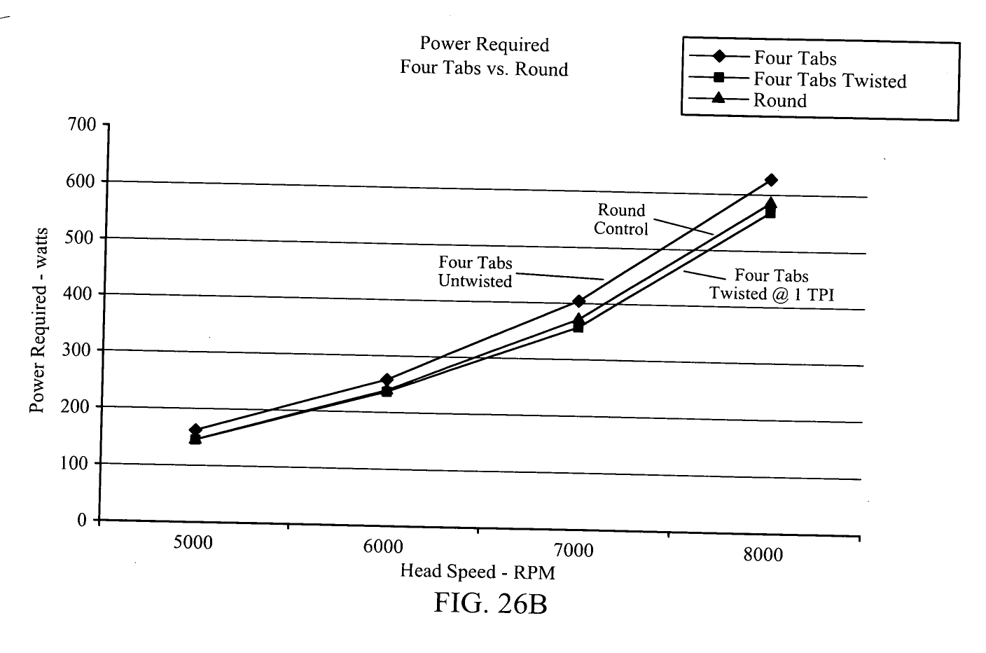

A final set of noise level comparison and power level comparison is shown in FIGS. 26A and 26B for a line which is configured of four tabs or small protrusions located at 90° angular intervals about the circumference of the cross section of the line. This four-tabbed line again is compared in twisted and untwisted configurations, as illustrated in the comparison charts. Once again, it is readily apparent that the twisted configuration provides significantly lower noise level than the untwisted version, although the power required is comparable for all versions.

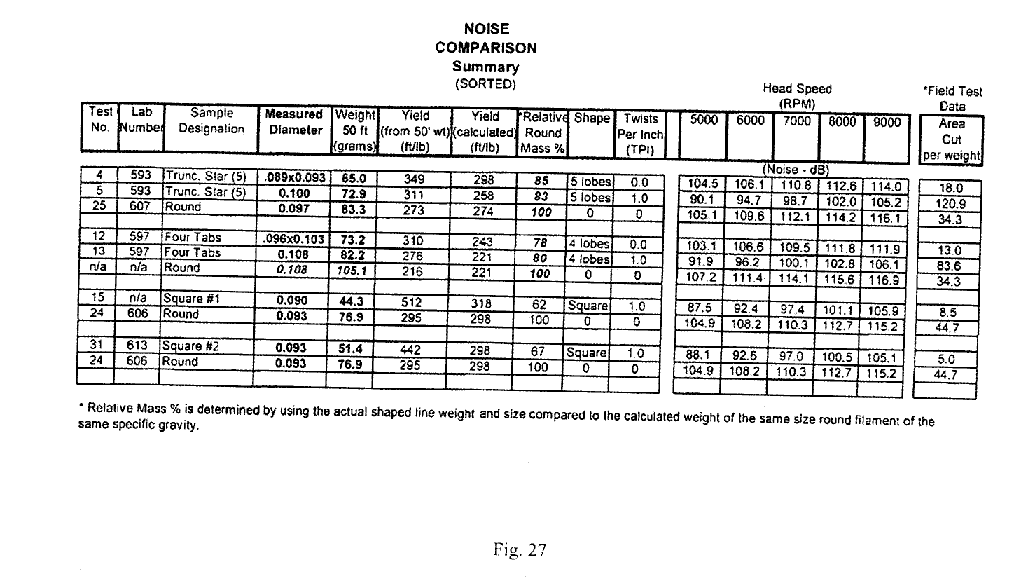

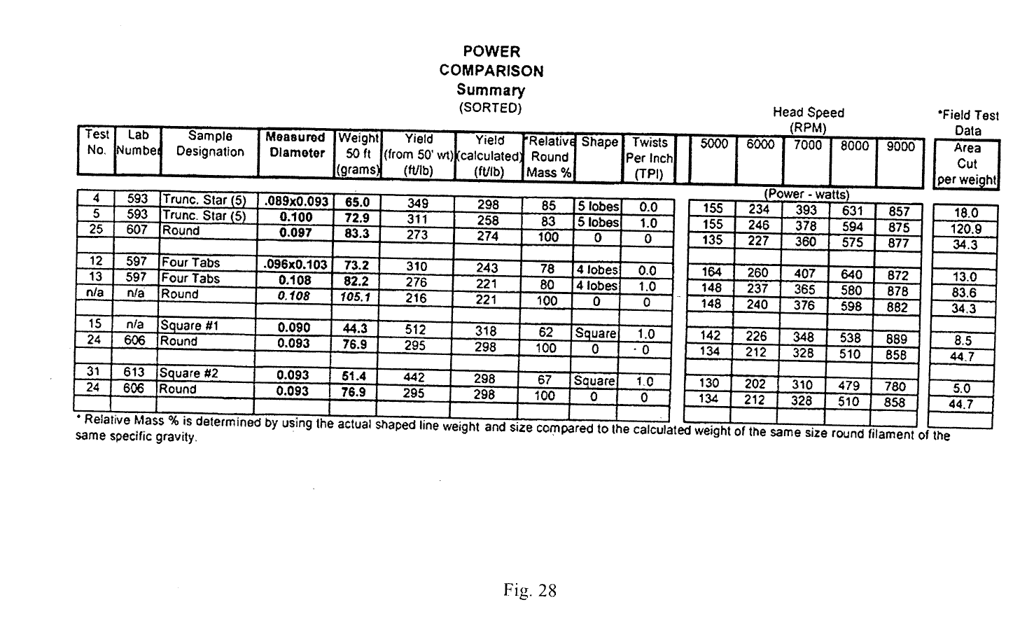

FIGS. 27 and 28 are charts providing a noise comparison summary and a power comparison summary, respectively, corresponding to the graphs which are found in FIGS. 22A through 26B. These charts provide comparison information for tests which were run on the different lines. On both FIGS. 27 and 28, the right-hand area called “Field Test Data” and further entitled “Area Cut Per Weight” is illustrative of the unexpected results which were obtained by the combination of twisting the lines of various configuration and maintaining the mass in the 80% or greater ratio to a comparably sized round cross-sectional configuration line.

In performing the field tests which resulted in the “area cut per weight” measurements, the unexpected results of the combination become readily apparent. In FIGS. 27 and 28, the round line of comparable cross-sectional size (as seen in the measured diameter column) provides the control or standard against which the measurements are made. Also, as is apparent from an examination of FIGS. 27 and 28, the truncated star (twisted and untwisted) and the four tabs (twisted and untwisted) was compared against comparable round line, as well as the No. 1 square and No. 2 square lines which are charted in FIGS. 22A and B and 23A and B.

As noted above, the No. 1 square and No. 2 square lines of FIGS. 22A/B and 23A/B fail to have the relative mass percentage of 80% or greater found by applicant to yield the unexpected and satisfactory results which appeared from the field test data of the other lines shown in FIGS. 27 and 28. Square No. 1 and square No. 2 lines, even when twisted with one twist per inch, included insufficient mass to provide satisfactory results in the amount (area) of vegetation cut, when compared with a round line of comparable cross-sectional circumference. This is shown by the round line comparison showing a relative cut area of 44.7 against 8.5 (for square No. 1 twisted) and 5.0 (for square No. 2 twisted). Clearly, the relatively lightweight per unit length of twisted square line causes the line to fail or wear out much more quickly than the conventional round cross-sectional line used for comparison purposes.

In contrast, however, to the results noted above for square No. 1 and square No. 2 twisted line, the results for the twisted truncated star (80% or greater mass) or the twisted four-tab line (80% or greater mass), as compared with a round line of comparable diameter for test purposes, produced lines which cut three to four times the area compared with the standard round line, as is readily apparent from FIGS. 27 and 28. When the same line, however, truncated star or four-tabbed, in an untwisted configuration was compared with the round line of comparable diameter, the untwisted Asks 13 versions did not perform as well as a conventional round line.

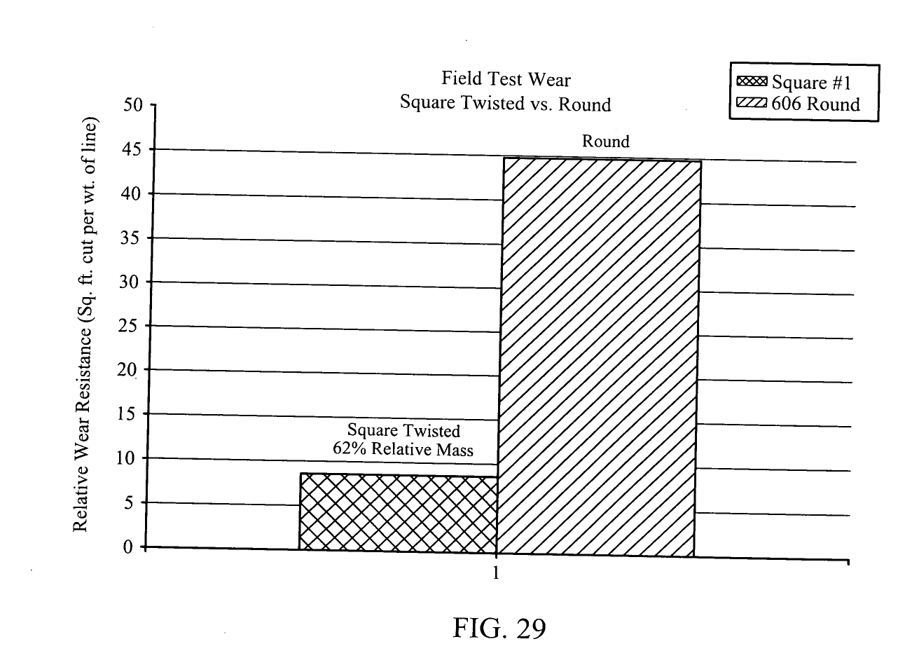

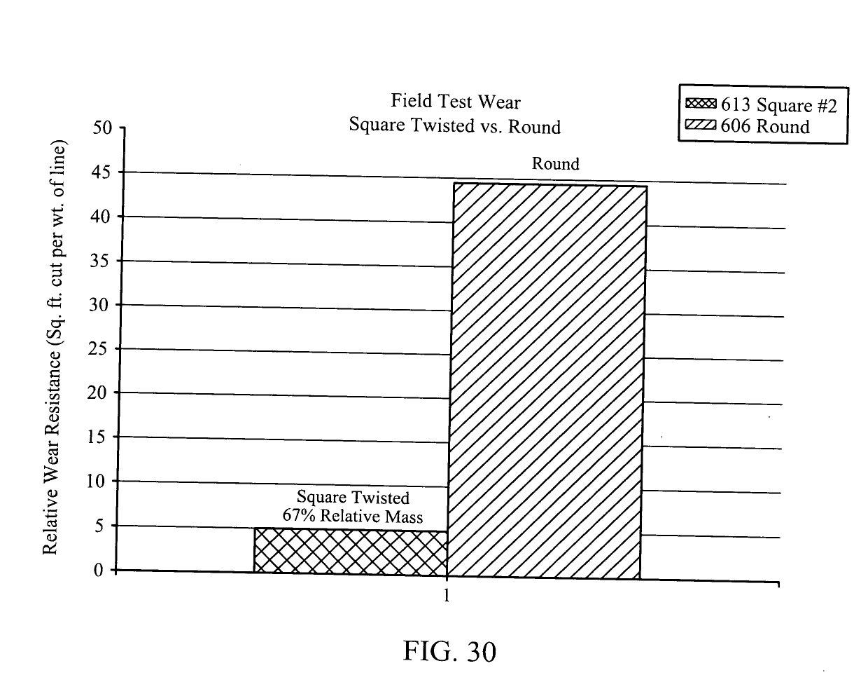

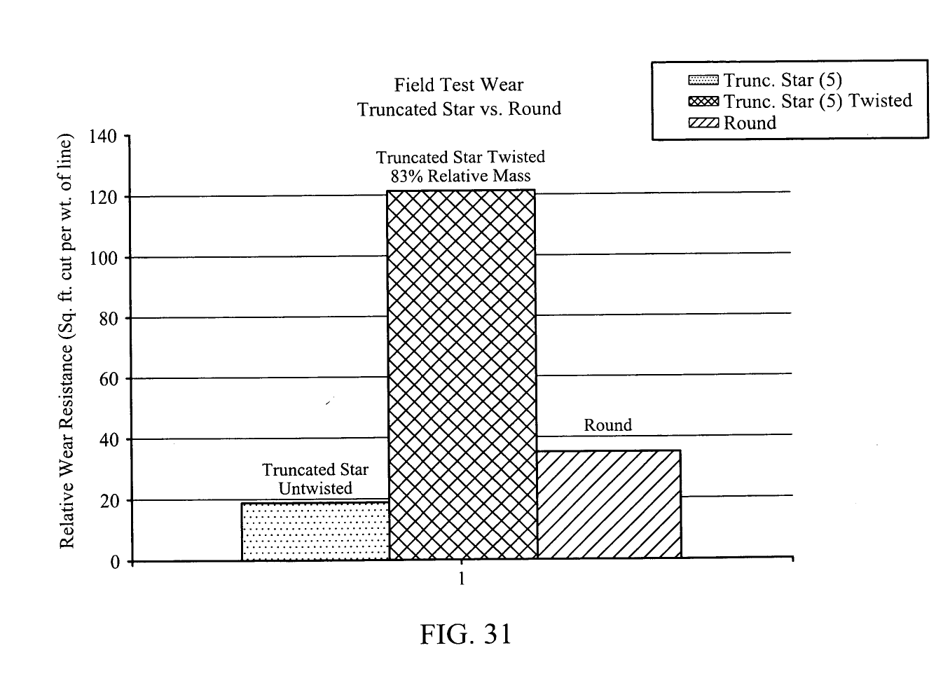

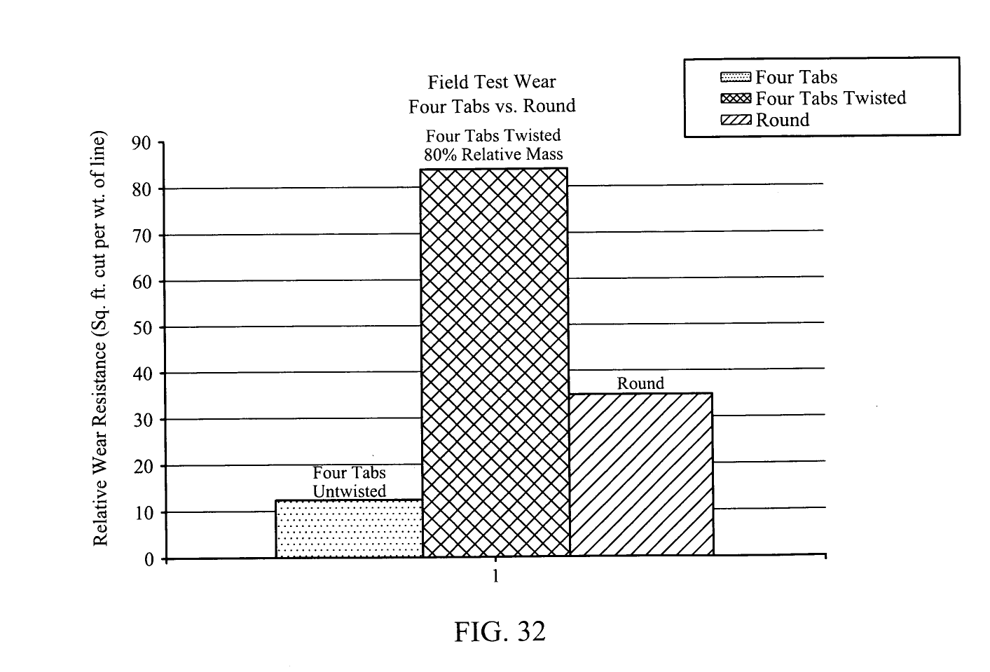

The information discussed above in conjunction with FIGS. 27 and 28 is depicted in a different form in FIGS. 29,30,31 and 32. The different lines which have been discussed above in conjunction with FIGS. 27 and 28 are shown in these four figures to compare the relative wear resistance in terms of square feet cut per weight of line, as conducted in actual field tests. In each of FIGS. 29 through 32, the round line configuration is shown as the standard against which the other configurations (twisted and untwisted) were tested. FIGS. 31 and 32 clearly show the superior results which were obtained from both the truncated star twisted line (having an 83% relative mass) and the four-tabbed twisted line (having an 80% relative mass) compared against the round line standard and the untwisted versions of each of these lines. The results indicate a synergism between the twisting and the relative mass of 80% or greater, defined for the various embodiments discussed above. The performance is significantly superior to the round cross-sectional control line having a greater mass per unit length and the untwisted versions of the same line producing the significantly improved wear characteristics when the line is twisted.

It is apparent from an examination of the various cross-sectional configurations which are employed with the practice of the invention described above that the invention is capable of use in a large number of different overall shapes to form the rotated lobe or twisted line of the invention. The foregoing description of the various embodiments of the invention is to be considered as illustrative and not as limiting.

Various other changes and modifications will occur to those skilled in the art for accomplishing substantially the same functions, in substantially the same way, to achieve substantially the same result, without departing from the true scope of the invention as defined in the appended claims.

What is claimed is:

1. An elongated length of string trimmer line including: a filament body having a non-circular cross-sectional shape and a longitudinal axis, wherein the filament body contains 80% or more of the total mass of a length of comparable string trimmer line having a circular cross section of a diameter equal to the diameter of a circle circumscribing the cross-sectional shape of the filament body wherein cross sections perpendicular to the longitudinal axis of the main filament body spaced along the length of string trimmer line are the same, and wherein the trimmer line is rotated about the longitudinal axis of the main filament body by from about 0.25 to 2.0 rotations per inch.

2. An elongated length of string trimmer line according to claim 1 wherein each cross section of the filament body has between three and twelve lobes protruding therefrom.

3. An elongated string trimmer line according to claim 2 wherein the rotation of the trimmer line about the longitudinal axis of the filament body causes the lobes to form between 0.75 to nodes per inch.

4. An elongated length of string trimmer line according to claim 3 wherein the rotation of the lobes about the longitudinal axis of the filament body is uniform throughout the length of the string trimmer line.

5. An elongated length of string trimmer line according to claim 4 wherein the protruding lobes are symmetrically placed around the periphery of the filament body.

6. An elongated length of string trimmer line according to claim 4 wherein the protruding lobes are asymmetrically located around the filament body.

7. An elongated string trimmer line according to claim 1 wherein the rotation of the trimmer line about the longitudinal axis causes formation of between 0.75 to 24 nodes per inch.

8. An elongated length of string trimmer line according to claim 1 wherein protruding lobes are symmetrically placed around the periphery of the filament body.

9. An elongated length of string trimmer line according to claim 1 wherein protruding lobes are asymmetrically located around the filament body.

10. An elongated length of string trimmer line according to claim 2 wherein the protruding lobes are symmetrical in shape.

11. An elongated length of string trimmer line according to claim 2 wherein the protruding lobes are asymmetrical in shape.

12. An elongated length of string trimmer line according to claim 2 wherein the rotation of the lobes about the longitudinal axis of the main filament body is uniform throughout the length of string trimmer line.

13. An elongated length of string trimmer line including: a main filament body having a longitudinal axis, the filament body containing at least 80% of the total mass of a length of comparable string trimmer line having a circular cross section of a diameter equal to the diameter of a circle circumscribing the cross-sectional shape of the filament body; and a plurality of protruding lobes extending from the filament body in a uniform spiral configuration along the length of the filament body to form a continuous rotating spiral pattern which varies continuously by a constant amount along the longitudinal axis of the filament body, with the rotation of the protruding lobes being between 0.25 to 2.0 rotations per inch of the filament body.

14. A string trimmer line according to claim 13 wherein the number of protruding lobes is between three and twelve.

15. A string trimmer line according to claim 14 wherein the lobes are equi-angularly spaced about the periphery of the filament body at each cross section thereof.

16. A string trimmer line according to claim 15 wherein the plurality of lobes all are of the same shape.

17. A string trimmer line according to claim 15 wherein the protruding lobes are of different shapes.

18. A string trimmer line according to claim 13 wherein the protruding lobes are of different sizes.

19. A string trimmer line according to claim 13 wherein the number of rotations of the lobes and the number of lobes is selected to form between 0.75 to 24 nodes per inch of length of the filament body.

20. A string trimmer line according to claim 13 wherein the plurality of lobes all are of the same shape.

21. A string trimmer line according to claim 13 wherein the protruding lobes are located symmetrically around the longitudinal axis of the filament body.

22. A string trimmer line according to claim 13 wherein the protruding lobes are symmetrical in shape.

23. A string trimmer line according to claim 13 wherein the protruding lobes are asymmetrical in shape.

24. A string trimmer line according to claim 13 wherein the protruding lobes are of different shapes.
